(19) United States
(12) Patent Application Publication
(10) Pub. No.: US 2018/0243050 A1
(43) Pub. Date: Aug. 30, 2018

(54) PORTABLE ORAL IRRIGATOR KIT

(71) Applicants: Stephen Raynor, Maple Hill, NC (US); Elizabeth Raynor, Maple Hill, NC (US)

(72) Inventors: Stephen Raynor, Maple Hill, NC (US); Elizabeth Raynor, Maple Hill, NC (US)

(21) Appl. No.: 15/441,531

(22) Filed: Feb. 24, 2017

(51) Int. Cl. A61C 1/00; A61C 17/02; A61C 19/02; A61H 13/00; A61J 9/00

(52) U.S. Cl. CPC A61C 1/0084; A61C 17/0202; A61J 9/00; A61H 13/005; A61C 19/02

(57) ABSTRACT

A travel kit and method of use for an oral irrigator that includes: a case, where the case includes a lid and a base; a cradle within the base, where the cradle receives the oral irrigator for storage; a water supply tube extending from the oral irrigator; an irrigation tube adapted to connect to the oral irrigator during use; and a water supply connector, where the water supply connector connects the irrigator to a water bottle during use.

### BACKGROUND OF THE INVENTION

### Field of Invention

The present invention relates to a portable oral irrigator kit.

### Description of Related Art

Overall, techniques of dental hygiene have expanded and include various innovative utensils used by many consumers. Traditionally oral hygiene was principally accomplished through the use of a toothbrush with toothpaste. The importance of flossing has expanded so many individuals may use both brushing and flossing as principal forms of oral hygiene. In addition to flossing, electrical toothbrushes are now more commonly used and are available for purchase at many retail environments. In addition to these basic utensils, use of oral irrigators have become quite common. Oral irrigators provide a jet stream of pressured water to help remove crack and debris from corners and crevices of a user's mouth. Typically, these oral irrigators are quite bulky and require a stand or other base for support when not in use. However, it would be advantageous to have a portable oral irrigator that could be easy to travel with in the form of a kit.

### SUMMARY OF THE INVENTION

The present invention relates to a travel kit for an oral irrigator that includes: a case, where the case includes a lid and a base; a cradle within the base, where the cradle receives the oral irrigator for storage; a water supply tube extending from the oral irrigator; an irrigation pick adapted to connect to the oral irrigator during use; and a water supply connector, where the water supply connector connects the irrigator to a water bottle during use.

The present invention further relates to a method of portable oral irrigator use and transport including the steps of: placing an oral irrigator into a cradle within a case; placing an irrigation pick into the case; placing a water supply connector into the case; placing a water supply tube into the case; removing components from the case for remote use; inserting the water supply tube to a water bottle; connecting the water supply tube to the water bottle with the water supply connector; and activating the oral irrigator for use.

### BRIEF DESCRIPTION OF DRAWINGS

FIG. 1 depicts an oral irrigator kit in accordance with the present invention.

FIG. 2 depicts the oral irrigator kit shown with a water bottle in accordance with the present invention.

FIG. 3 depicts the oral irrigator kit connected to a water bottle in accordance with the present invention.

### DETAILED DESCRIPTION

The present invention relates to an oral irrigator in the form of a portable travel kit. The oral irrigator according to the present invention provides a travel enclosure for the oral irrigator, therefore giving a user convenient to travel with and protect the oral irrigator.

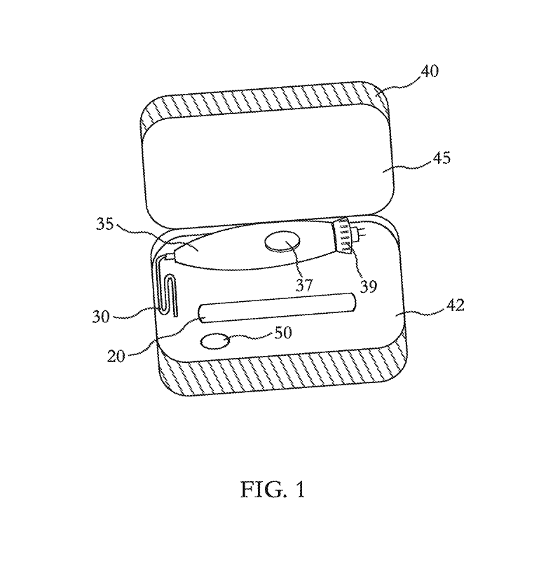

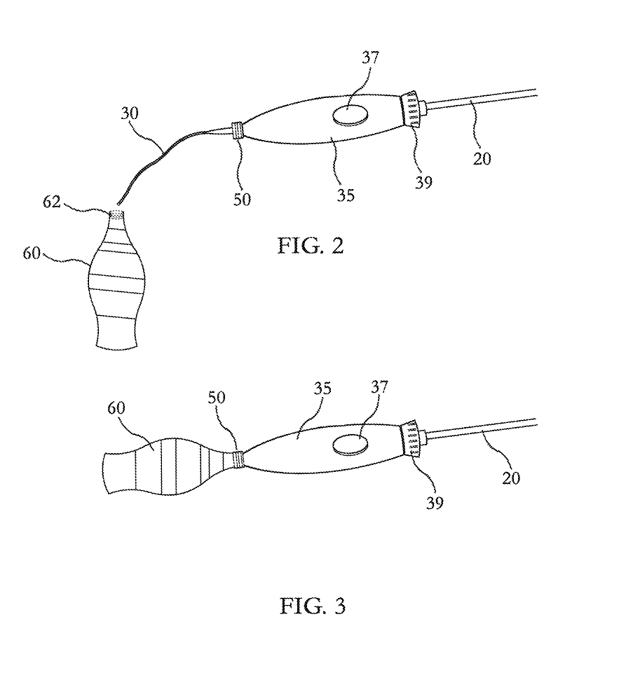

In reference to FIG. 1, an oral irrigator kit 100 is shown, where a case includes a top lid 40 and base 42 to enclose an oral irrigator 35. The oral irrigator 35 includes a power button 37 with an irrigator pick 20 adapted to extend from one end of the irrigator 35. This tube 20 extends from a connector 39 and may be placed within the case provided. The case includes an inner cavity 45 to allow space for insertion of the irrigator 35. The irrigator 35 sits within a cradle that is provided within the base 42. This kit 100 provides a unique travel kit for use of an oral irrigator that closes and seals the oral irrigator for travel purposes. A tube 30 extends from the oral irrigator 35 that enables connection to a water source. This oral irrigator 35 therefore gives the user a portable utensil for oral hygiene while traveling. The oral irrigator 35 includes a connector 50 used to connect the irrigator 35 to a water source. The connection to a water bottle 60 is shown in FIGS. 2 and 3. As shown, tube 30 travels through connector 50 for insertion into bottle 60. The tube 30 extends into the water bottle 60 and enables the supply of water into the irrigator 35. The connector 50 secures to the water bottle 60 as shown in FIG. 3. The irrigator pick 20 connects to the connector 39 through a quick release connection as shown in FIGS. 2 and 3. Once connected the irrigator 35 and bottle 60 are used together by the user. A user may use water from the water bottle 60 as shown to effectively use the irrigator 35 while traveling or at work.

The instant invention has been shown and described in what it considers to be the most practical and preferred embodiments. It is recognized, however, that departures may be made there from within the scope of the invention and that obvious modifications will occur to a person skilled in the art.

What is claimed is:

1. A travel kit for an oral irrigator comprising:
a. a case, where the case includes a lid and a base;
b. a cradle within the base, where the cradle receives the oral irrigator for storage;
c. a water supply tube extending from the oral irrigator;
d. an irrigation pick adapted to connect to the oral irrigator during use; and
e. a water supply connector, where the water supply connector connects the irrigator to a water bottle during use.

2. A method of portable oral irrigator use and transport comprising the steps of:
a. placing an oral irrigator into a cradle within a case;
b. placing an irrigation pick into the case;
c. placing a water supply connector into the case;
d. placing a water supply tube into the case;
e. removing components from the case for remote use;
f. inserting the water supply tube to a water bottle;
g. connecting the water supply tube to the water bottle with the water supply connector; and
h. activating the oral irrigator for use.
